(19) United States
(12) Patent Application Publication
(10) Pub. No.: US 2013/0150192 A1
(43) Pub. Date: Jun. 13, 2013

(54) COMPLIANT GUIDE DEVICE

(71) Applicants: Ludwik W. Cholewczynski, Rochester, MI (US); Stan M. Mashkevich, White Lake, MI (US)

(72) Inventors: Ludwik W. Cholewczynski, Rochester, MI (US); Stan M. Mashkevich, White Lake, MI (US)

(73) Assignee: CHRYSLER GROUP LLC, Auburn Hills, MI (US)

(21) Appl. No.: 13/315,343

(22) Filed: Dec. 9, 2011

(51) Int. Cl. F16H 7/08; F16H 7/18

(52) U.S. Cl. 474/111; 474/140

(57) ABSTRACT

A compliant guide device for a chain or a belt is provided. The compliant guide device includes a contact section and a mounting section. The contact section is configured to compliantly contact both a slack side and a tension side of the chain or belt. The mounting section is configured to be moveably mounted about a shaft utilized with the chain or belt.

### FIELD

The present disclosure relates to a compliant guide device and, particularly, to shaft-chain system that reduces chain vibrations.

### BACKGROUND

In belt and pulley and chain and sprocket systems, vibrations cause wear and noise and can result in reduced belt and chain life. Guides and tensioners are used to reduce vibration and maintain proper chain/belt position during operation. In one application of a chain and sprocket system connecting the crankshaft of the engine of an automotive vehicle to a balance shaft, spikes in vibration of the crankshaft caused by system resonance or misfiring may cause the chain to vibrate and separate from traditional chain guides. This vibration can cause undesirable noise and premature wear or failure of the chain and the chain guide. A number of techniques have been used over time to address this issue.

FIG. 1 shows one approach that has been used to address the problem as disclosed in U.S. Pat. No. 7,241,240, herein incorporated by reference. FIG. 1 shows a typical crankshaft 10 of an automotive vehicle engine having a sprocket 12 secured on one end thereof. A balance shaft 14 spaced from the crankshaft has a sprocket 16 secured on one end. A chain 20 extends over and around the sprockets 12 and 16. The chain has chain links 21 engaging teeth 22 on sprocket 12 and teeth 24 on sprocket 16. Rotation of the crankshaft 10 is transmitted to the balance shaft 14 through the sprockets 12 and 16 and the chain 20 so that sprocket 12 may be considered the drive sprocket and sprocket 16 may be considered the driven sprocket. In this description, the crankshaft 10 will be presumed to rotate in the direction of arrow A in FIG. 1 so that of the two sections of the chain 20 extending between the sprockets 12 and 16, one is the tension side 26 and the other is the slack side 28.

A fixed chain guide 30 engages the tension side 26 of the chain 20. A flexible chain guide 32 engages the slack side 28. The flexible chain guide 32 is mounted to the engine block 48 by fasteners 44 and 46. The design of the flexible chain guide 32 itself along with a generally U-shaped reinforcing strip 54 bias the chain guide to maintain contact with the chain. Therefore, there is room for improvement in the art.

### SUMMARY

The compliant guide device of the present disclosure absorbs vibrations thus minimizing chain wear and extends chain life. This is achieved by providing compliant contact on both the slack and tension sides of the chain while allowing the entire device to move, e.g. rotate, about the balance shaft. The compliant guide device of the present disclosure also utilizes few parts and a simplified mounting scheme resulting in lower cost.

In one form, the present disclosure provides a compliant guide device including a contact section configured or biased toward compliant contact with both a slack side and a tension side of a chain or belt and a mounting section configured to be rotatably mountable about a shaft carrying a sprocket or pulley for the chain or belt. The contact section and the mounting section can be separate parts or different sections of a single unitary structure. In one form, one portion of the contact section may have more bias for urging the portion toward contact with one portion of the chain or belt compared to the other portion. For example, a portion of the contact section is more biased toward contact with a slack side of the chain or belt compared to another portion of the contact section having a lesser amount of bias for contacting the tension side of the chain or belt.

In another form, the present disclosure provides a compliant chain system for an automotive engine comprising a mounting section rotatably mounted about a balance shaft of the automotive engine and a chain contacting section attached to the mounting element for contacting the chain. The compliant chain system is arranged such that a tension side section of a leaf spring is urged in some amount toward contact with the tension side of the chain and a slack side section of the leaf spring is urged in some amount toward contact with the slack side of the chain during the operation. In one form, the leaf spring is utilized with the contact section in a manner where the leaf spring urges the contact section toward contact with the chain.

In another form the present disclosure provides a method of installing a compliant chain system which includes positioning a mounting section of the compliant chain system about a balance shaft of an automotive engine, installing a sprocket on the balance shaft. The compliant chain system is free to move about the balance shaft and the sprocket retains the compliant chain system about the balance shaft. The method may also include installing a balance chain on the sprocket such that both the tension side of the chain and the slack side of the chain are in contact with a chain contacting portion of the compliant chain system and installing a leaf spring as part of the compliant chain system, wherein installing the leaf spring includes attaching a cover to the mounting section in order to hold the leaf spring in place.

Further areas of applicability of the present disclosure will become apparent from the detailed description and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is an end view of an engine utilizing a prior art chain system;

FIG. 2 is a perspective view of a mounting piece of a compliant chain system in accordance with the present disclosure;

FIG. 3 is a perspective view of a chain contacting element installed on a mounting piece of a compliant chain system in accordance with the present disclosure;

FIG. 4 is a perspective view of a leaf spring installed on the assembly from FIG. 2 in accordance with the present disclosure; and

FIG. 5 is a perspective view of a cover installed on the system in accordance with the present disclosure.

### DETAILED DESCRIPTION

The present disclosure provides a compliant guide device for use with a chain or a belt-shaft system. For example, a compliant guide device can be utilized with a chain-shaft system to minimize and absorb vibrations, for example chain vibrations. In one embodiment, the compliant chain system includes a biasing member toward contact with both the slack and tension sides of the chain. The compliant guide device is configured, including the amount of biasing force, to maintain some amount of contact with portions of the chain yet in a manner to accommodate chain movement fluctuations without undue force against the chain and in a manner to dampen or minimize chain vibrations. The disclosed compliant chain system can also be mounted about the shaft such that the compliant guide device can move, e.g. rotate, about the shaft to aid in absorbing vibrations. Additionally, the compliant guide device comprises few components resulting in a simpler and less expensive solution to chain vibration problems.

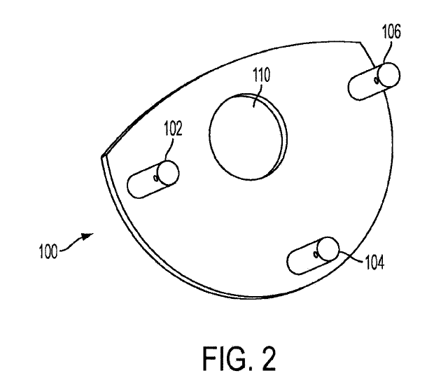

Referring now to the drawings, FIGS. 2-5 illustrate an embodiment of a compliant guide device for use with a compliant chain system according to the present disclosure. FIG. 2 shows mounting section or piece 100, which is generally flat with a mounting hole 110 provided there through. Projecting upward from mounting piece 100 are three posts 102, 104, 106. As will be discussed below, posts 102, 104, 106 are used to locate and mount other components in the system. Mounting piece 100 can be made from a variety of materials, including but not limited to, metal or plastic. Mounting hole 110 is sized such that it fits about the balance shaft 14 of an automotive engine while still allowing for rotation of the compliant guide device about the balance shaft 14. For example, the mounting hole 110 can be sized to mount over a portion of a housing about the shaft where the mounting piece is proximate the chain. In this embodiment, the mounting piece may be snuggly fitted to the housing yet permit some movement of the mounting piece relative to the housing.

In an exemplary embodiment, the assembled compliant guide device or compliant chain system is mounted about balance shaft 14 prior to sprocket 16 such that the compliant chain system is positioned between the engine block 48 and sprocket 16. This is a fundamental difference between the disclosed compliant chain system and traditional chain guide and tensioner systems, which are generally mounted via fasteners to the engine block. The ability of the disclosed compliant chain system to rotate about the balance shaft works in concert with a biased contact portion of the device to absorb vibrations and maintain an amount of guiding contact with both the slack side and tension side of the chain during operation. In an alternative embodiment, the housing and mounting piece can have a locating feature (e.g. a tab of the mounting section to engage a space of the housing) yet still permit some movement between the complaint guide device about the shaft so the chain better accommodates vibrations due to complaint contact with the chain sides.

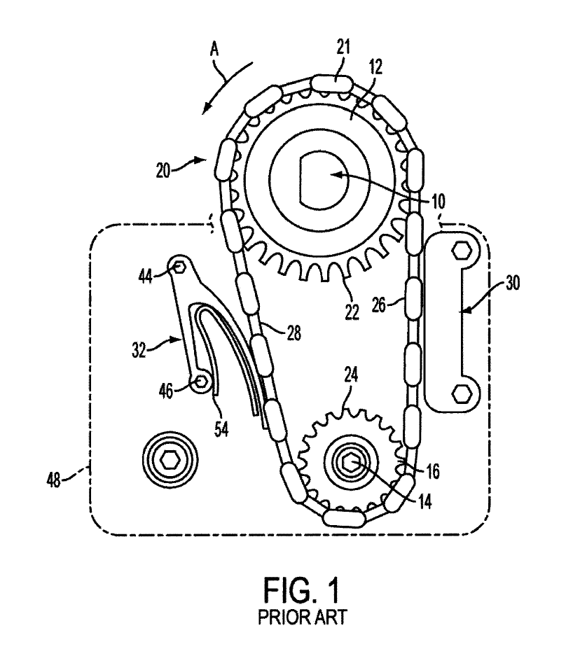

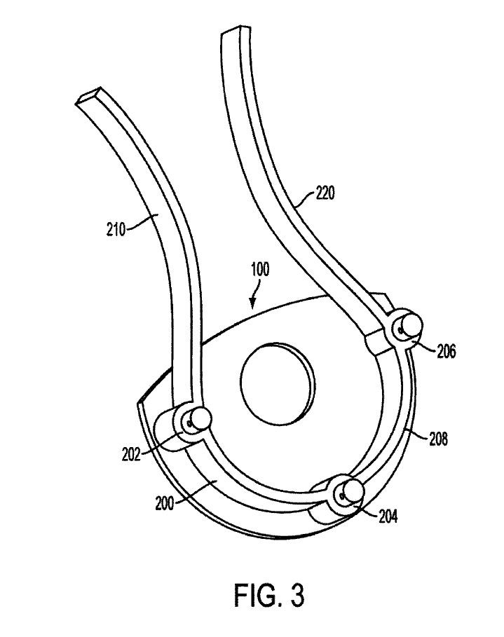

FIG. 3 shows a chain contacting section or element 200 installed on mounting piece 100. Chain contacting element 200 has three mounting features 202, 204, 206, which are made up of generally circular portions with holes defined there through. Chain contacting element 200 is installed on mounting piece 100 by aligning and sliding posts 102, 104, 106 through the holes of mounting features 202, 204, 206. Chain contacting element 200 further includes a slack side section or extension 210 and a tension side section or extension 220. When assembled and mounted the balance chain (20 in FIG. 1) is positioned between the slack side extension 210 and the tension side extension 220 of the contacting element 200. Thus, slack side extension 210 pushes inwardly on the slack side 28 of the chain 20 and tension side extension 220 pushes inwardly on the tension side 26 of the chain 20. In one exemplary embodiment, both the slack side extension and the tension side extension are each biased with a substantially similar force toward contact with respective portions of the chain. In another embodiment, one of the tension side extension or the slack side extension may have a greater biasing force toward contact with the respective side of the chain. For example, in one application configuration, it may be more desirable to bias the slack side extension more toward the slack side of the chain compared to the tension side. In another application, a mounting piece arrangement/orientation relative to the housing shape/configuration may dictate one of the slack side extension or tension side extension have more bias toward contact with respective side of the chain. In these embodiments, it still is desirable for some movement, compliance, between the mounting piece and the portion it is mounted about, here the housing, to better accommodate chain vibrations.

Chain contacting element 200 can be made from a number of materials including, but not limited to, metals and plastics. In one exemplary embodiment, a portion or more of the chain contacting element 200 is made from a plastic material with desirable, e.g. very low, frictional properties. In another embodiment, the contacting element may include a material that provides lubricating properties for the portions in contact with the chain. While shown as two separate elements it is also anticipated that mounting piece 100 and chain contacting element 200 could be made as a single unitary structure. For instance a single plastic piece could be used in place of mounting piece 100 and chain contacting element 200 to achieve desirable results.

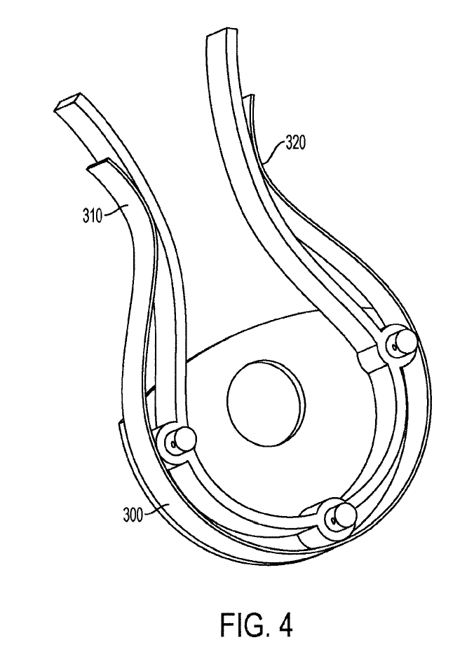

FIG. 4 shows the compliant chain system with a leaf spring 300 in accordance with another exemplary embodiment. Leaf spring 300 includes slack side section 310 and tension side section 320. Here, leaf spring 300 wraps around chain contacting element 200 and urges portions of the contacting element to compliance contact with the chain. Slack side section 310 is biased toward contact with the slack side extension 210 of the contacting element and tension side section 320 is biased toward contact with the tension side extension 220 contacting element. Sections 310, 320 of the leaf spring 300 squeeze or bias extensions 210, 220 inward to maintain contact between the extensions 210, 220 and the chain 20. Leaf spring 300 is generally made from spring steel, but may be made from other suitable materials, e.g. plastic/lubricating material, that provides desirable spring or biasing properties.

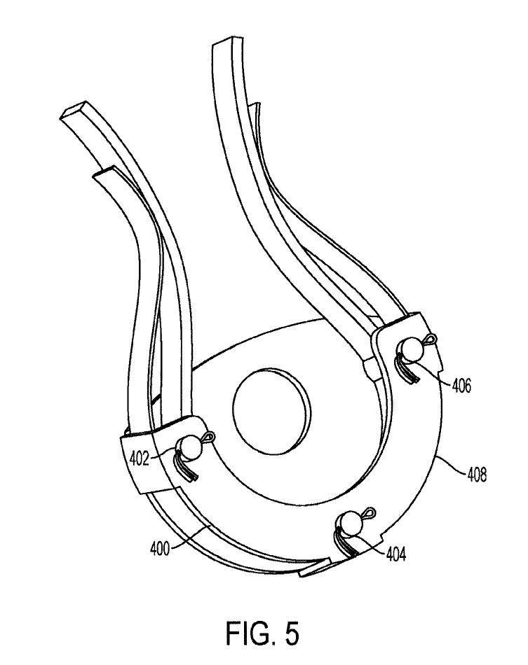

FIG. 5 shows a cover 400 that holds leaf spring 300 in place relative to the mounting section. Cover 400 includes holes 402, 404, 406, which when installed align with posts 102, 104 and 106. Cover 400 also includes tabs that protrude down from edge 408 such that, when installed, leaf spring 300 is located between the tabs and the outer surface 208 of chain contact element 200. Cover 400 is installed by sliding posts 102, 104, 106 through holes 402, 404, 406. Cotter pins placed through the holes in posts 102, 104, 106, or other known fastening techniques, may be used to hold cover 400 in place.

While the above description describes a system having four components mounting piece 100, chain contacting element 200, leaf spring 300, and cover 400, other combinations exist which embody the disclosed invention. As mentioned above, it may be possible to manufacture or mold mounting piece 100 and chain contacting element 200 as single part, such as one made from a plastic material. In this case it may be beneficial to also make cover 400 from a plastic material. When plastic materials are used for one or more of the components, it may be beneficial to also utilize plastic 102, 104, 106 closures to hold cover 400 in place. Additionally it may be possible to form the device as a single piece by utilizing an insert molding process in which a plastic part is formed that partially or entirely encapsulates a leaf spring 300. Plastic and other lightweight materials are preferably used to minimize the moment of inertia and reduce the resistance to rotation. This allows the device to easily rotate about the shaft promoting absorption of torsional vibrations.

The compliant chain system absorbs vibrations in the chain by the combination of the deflection of the biasing members or extensions 210, 220, and sections 310, 320 if utilized, and the movement of the entire device about the shaft. The combination of the biasing members contacting on both slack and tension sides of the chain with the freedom of the device to rotate or move about the shaft provides absorption of vibrations. Additionally, this device configuration promotes that the biasing members maintain a desirable contact with both sides of the chain during operation, maintaining optimal vibration absorption and reduce wear on the chain from excessive contact with the chain.

The relatively simple mounting scheme of the disclosed compliant chain system provides reduced cost. By rotationally mounting the compliant chain system about the shaft, traditional fasteners are no longer necessary. Additionally, there is no need to drill and tap mounting holes in the engine block for mounting the system, thus reducing manufacturing time and costs. When compared to the device shown in FIG. 1, the compliant guide device or compliant chain system of the current disclosure replaces two separate guides, fixed chain guide 30 and the combination of flexible chain guide 32 and reinforcing strip 54, along with the fasteners utilized to secure these components.

While the current disclosure describes the compliant guide device in the context of balance chains for automotive engines the invention is not limited to this application. It should be appreciated that the compliant guide device of the current disclosure can be utilized in a variety of applications to provide superior cost effective absorption of torsional chain vibrations. It should also be appreciated that the disclosed device may also be used with belt system to provide similar benefits.

What is claimed is:

1. A compliant guide device for a belt or chain comprising:
a contact section configured to have compliant contact with both a slack side and a tension side of the chain or belt; and
a mounting section configured to be movably mountable about a shaft utilized with the chain or belt.

2. The compliant guide device of claim 1, wherein the contact section includes a portion more biased toward contact with one of the slack side or the tension side of the chain or belt.

3. The compliant guide device of claim 1, further comprising a leaf spring, the leaf spring having a tension side section and a slack side section, the tension side section biased toward contact with the tension side of the chain or belt, the slack side section biased toward contact with the slack side of the chain or belt.

4. The compliant guide device of claim 3, wherein one of the slack side section or the tension side section is more biased toward contact with the chain or belt than the other section.

5. The compliant guide device of claim 1, further comprising a cover joined to the mounting section.

6. The compliant guide device of claim 3, wherein a portion of the leaf spring is made of metal.

7. The compliant guide device of claim 1, wherein a portion of the contact section is made of plastic.

8. The compliant guide device of claim 1, wherein the contact section and the mounting section are different portions of a single unitary structure.

9. The compliant guide device of claim 8, wherein the single unitary structure includes a plastic material.

10. A compliant chain system for an engine, said system comprising:
a mounting section movably mounted about a shaft of the engine; and
a chain contacting section joined to the mounting section for contacting the chain.

11. The compliant chain system of claim 10, wherein the chain contacting section includes a portion more biased toward contact with one of a slack side or a tension side of the chain.

12. The compliant chain system of claim 10, further comprising a leaf spring, the leaf spring having a tension side section and a slack side section, the tension side section biased toward contact with a tension side of the chain, the slack side section biased toward contact with a slack side of the chain.

13. The compliant chain system of claim 12, wherein one of the slack side section or the tension side section is more biased toward contact with the chain than the other section.

14. The compliant chain system of claim 10, further comprising a cover joined to the mounting section.

15. The compliant chain system of claim 12, wherein a portion of the leaf spring is made of metal.

16. The compliant chain system of claim 10, wherein a portion of the chain contacting section is made of plastic.

17. The compliant chain system of claim 10, wherein a portion of the mounting section is made of plastic.
